(19) United States
(12) Patent Application Publication
(10) Pub. No.: US 2014/0007860 A1
(43) Pub. Date: Jan. 9, 2014

(54) SMOKELESS PORTABLE ROASTER

(71) Applicant: Chien-Chang LU, Tainan (TW)

(72) Inventor: Chien-Chang LU, Tainan (TW)

(21) Appl. No.: 13/544,982

(22) Filed: Jul. 9, 2012

(51) Int. Cl. F24C 1/16; F24C 7/10; A21B 1/52

(52) U.S. Cl. 126/19 M; 219/387

(57) ABSTRACT

A smokeless portable roaster includes a base tray, two side plates, a cover plate, a support plate and two hanging plates. The two side plates are respectively assembled at two opposite sides of the base tray, respectively composed of two folding plates pivotally combined together. The cover plate is pivotally mounted on the two side plates, having an upper side installed with a heater. The support plate is pivotally combined at another side of the cover plate, and the two hanging plates are respectively assembled at the front side and the rear side of the base tray and the two opposite side plates and the cover plate. Thus, the roaster can quickly be spread out for carrying out one-way or two-way roasting and can also be made into a box-type roaster to be used as an oven, able to be collapsed easily and quickly and convenient to be carried around.

### BACKGROUND OF THE INVENTION

1. Field of the Invention

This invention relates to a smokeless portable roaster, particularly to one that can quickly be spread out for carrying out one-way or two-way food roasting and also can be formed into an enclosed box-type roaster to be used as an oven, able to be collapsed quickly to diminish the whole volume for facilitating to be carried about.

2. Description of the Prior Art

As commonly known, a broiler frame is used for roasting food. A conventional broiler frame 1, as shown in FIG. 1, includes a frame body 10 having a roasting net 11 set thereon and a foot frame 12 threadably secured at the underside for supporting the broiler frame 1. However, the conventional broiler frame 1 is fixed in structure, and the frame body 10 and the foot frame 12 are impossible to be collapsed when the broiler frame 1 is not in use, thus taking too much space for depositing the broiler frame 1. In addition, the conventional broiler frame 1 is of an open type without any covering structure; therefore, during roasting food, heat energy produced by the broiler frame 1 is likely to disperse upward and outward to reduce effect of food roasting.

### SUMMARY OF THE INVENTION

The objective of this invention is to offer a smokeless portable roaster that can quickly be spread out for carrying out one-way or two-way food roasting and also can be made into a box-type roaster to be used as an oven, able to be easily and quickly collapsed to diminish the whole volume for facilitating the roaster to be carried around, attaining efficacies of energy conservation, carbon reduction and environmental protection.

The smokeless portable roaster in the present invention includes a base tray having two sides respectively provided with a pivot suspension for receiving a pivot. Two side plates are oppositely and pivotally assembled at the two sides of the base tray, respectively composed of two folding plates pivotally combined together, and the two folding plates have their upper and lower edges respectively disposed with a pivot suspension for receiving a pivot, with the pivot suspensions assembled with a pivot acting as a folding shaft. A cover plate is pivotally mounted on the two opposite side plates, having its peripheral sides respectively formed with a pivot suspension for receiving a pivot, and its upper side installed with a heater having topside provided thereon with a lifting handle. A support plate to be pivotally assembled at another side of the cover plate has its upper edge disposed with a pivot suspension to be pivotally connected with the pivot suspension at another side of the cover plate and is bored with a through hole. Two hanging plates are respectively fixed at the front side and the rear side of the base tray and the two opposite side plates and the cover plate.

The two folding plates of each side plate of the smokeless portable roaster in the present invention have a butt joint pivot suspension pivotally connected together by a pivot, and the two side plates have a pivot suspension at the lower edge pivotally combined with the pivot suspension at two sides of the base tray by means of a pivot. The cover plate is pivotally combined with the pivot suspension at the upper side of the two opposite side plates by a pivot, and the support plate has an upper pivot suspension pivotally assembled with the pivot suspension at another side of the cover plate by a pivot. Thus, all the members are pivotally combined with one another by means of a plurality of pivots.

The base tray, the two side plates, the cover plate and the two hanging plates of the smokeless portable roaster in the present invention can also be assembled together to make up a box-type roaster to be used as an oven.

The two side plates of the smokeless portable roaster in the present invention have their surfaces respectively and oppositely bored with at least one insert hole for an insert rod to be inserted therethrough and their opposite inner sides respectively fixed with a plurality of lugs for setting a roasting net thereon.

The cover plate of the smokeless portable roster in the present invention has two opposite upper sides respectively formed with two projections, and each hanging plate has its upper edge bored with two hanging holes for the hanging plate to be engaged on the two projections of the cover plate to enable the hanging plate to be stably hung at two sides of the cover plate.

The two hanging plates of the smokeless portable roaster in the present invention have their upper edges respectively bent to form a hanging lug so that the hanging plates can be horizontally hung on the front and the rear edges of the base tray for placing articles thereon, and each hanging plate has its wall surface disposed with a lifting lug to resist the ground or a table top for supporting the hanging plate.

### BRIEF DESCRIPTION OF DRAWINGS

This invention will be better understood by referring to the accompanying drawings, wherein:

FIG. 1 is a perspective view of a conventional broiler frame;

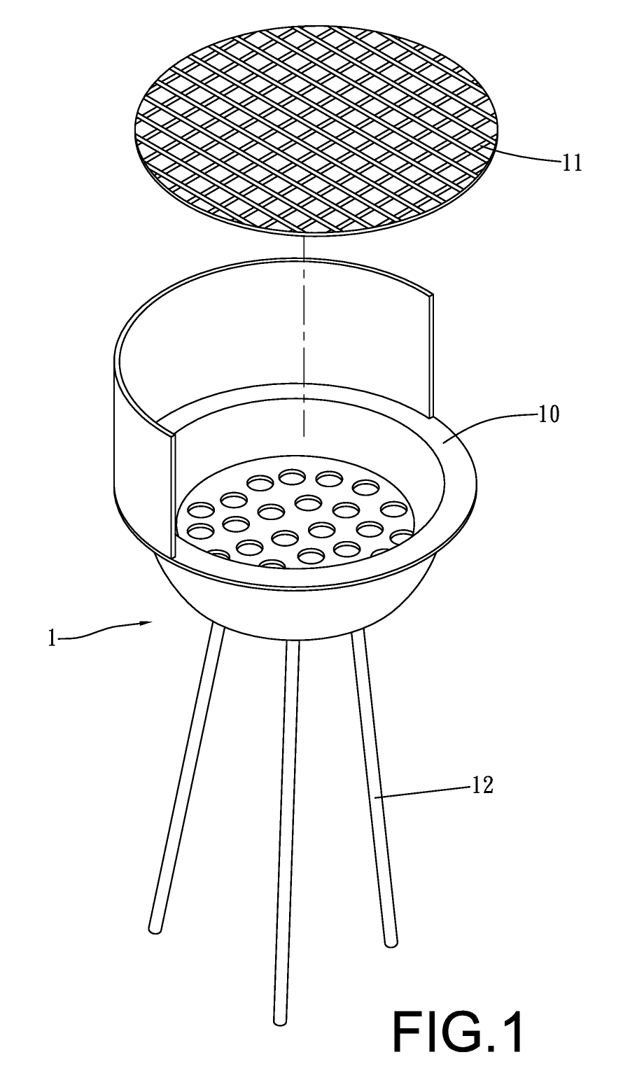

FIG. 2 is an exploded perspective view of a smokeless portable roaster in the present invention;

FIG. 3 is a perspective view of the smokeless portable roaster in the present invention;

FIG. 4 is a perspective view of the smokeless portable roaster in the resent invention;

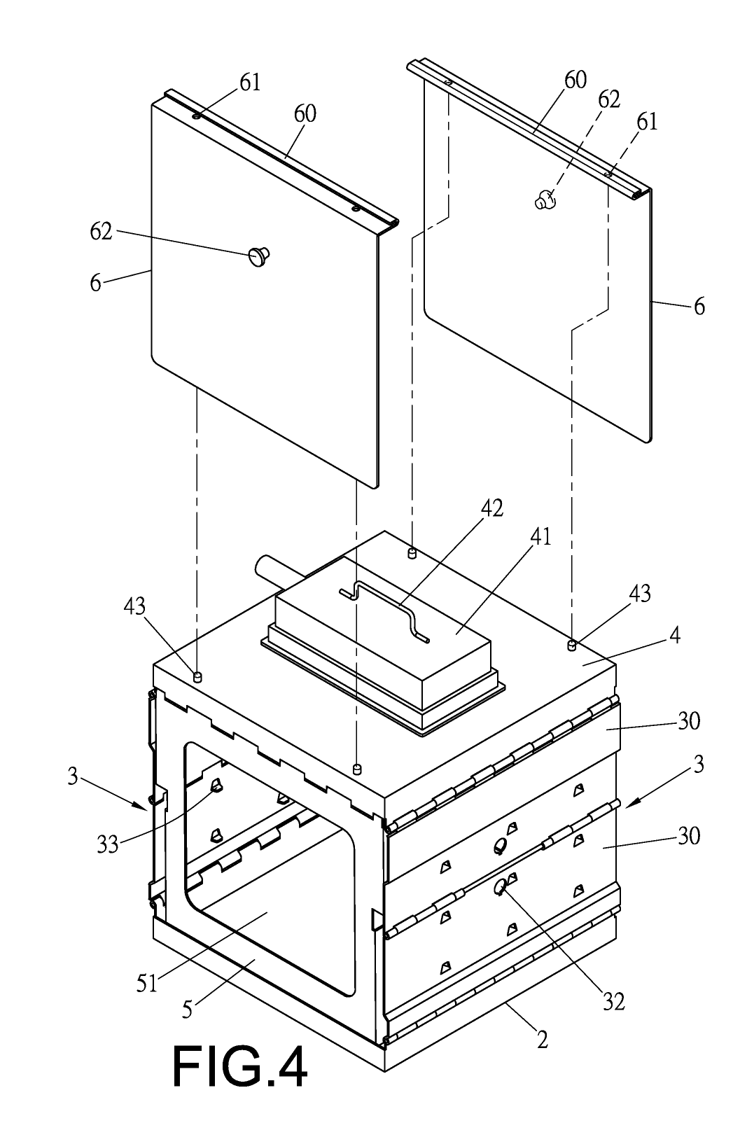

FIG. 5 is a perspective view of the smokeless portable roaster used for carrying out one-way roasting in the present invention;

FIG. 6 is a perspective view of the smokeless portable roaster used for carrying out two-way roasting in the present invention;

FIG. 7 is a perspective view of the smokeless portable roaster completely enclosed to be used as an oven in the present invention;

FIG. 8 is a perspective view of the smokeless portable roaster in the present invention, illustrating that a support plate is turned inward to be collapsed;

FIG. 9 is a perspective view of the smokeless portable roaster in the present invention, illustrating that two side plates are being collapsed; and

FIG. 10 is perspective view of the smokeless portable roaster in a completely collapsed condition in the present invention.

### DETAILED DESCRIPTION OF THE PREFERRED EMBODIMENT

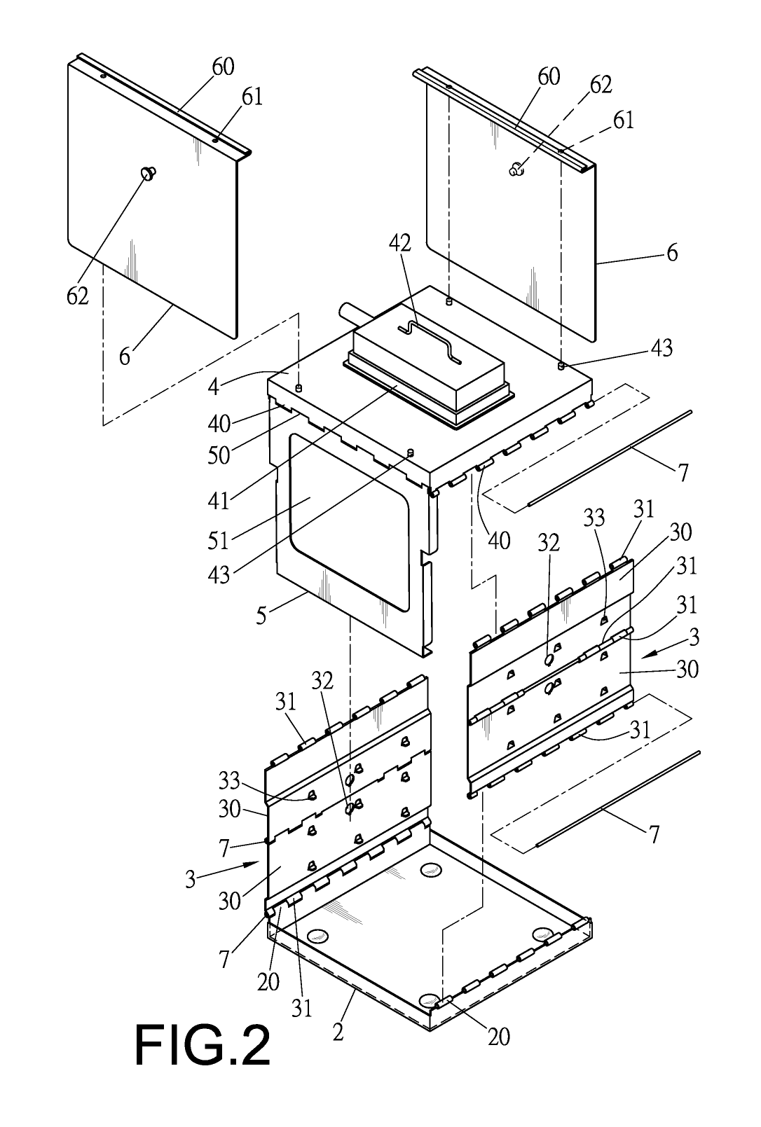

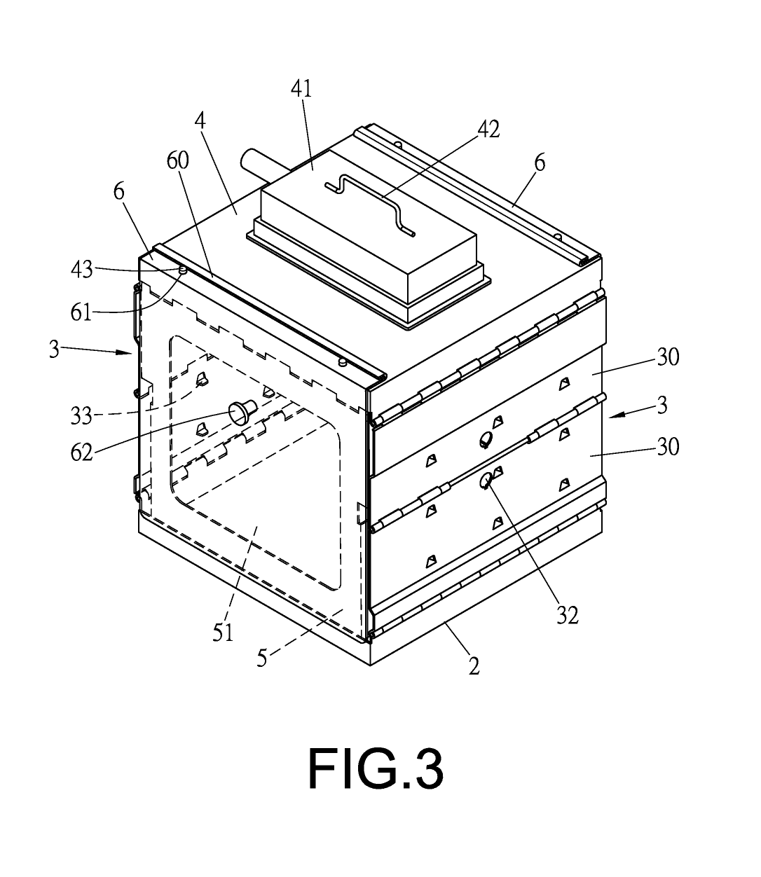

A preferred embodiment of a smokeless portable roaster in the present invention, as shown in FIGS. 2 and 3, includes a base tray 2, two side plates 3, a cover plate 4, a support plate 5 and two hanging plates 6 as main components combined together.

The base tray 2 has two opposite sides respectively provided with a pivot suspension 20.

The two side plates 3 are oppositely and pivotally assembled with the pivot suspension 20 at two sides of the base tray 2, respectively composed of two folding plates 30 pivotally combined together. Each folding plate 30 has an upper edge and a lower edge respectively formed with a butt joint pivot suspension 31 for receiving a pivot 7, and a central pivot suspension 31 formed at an intermediate portion of the two folding plates 30 is jointed by a pivot 7, with all the pivot suspensions 31 assembled with a pivot of the two folding plates 30 acting as a folding shaft. The two side plates 3 respectively have the lower pivot suspension 31 pivotally combined with the pivotal portion 20 at two sides of the base tray 2 by means of a pivot 7, further having their surfaces oppositely bored with at least one insert hole 32 and their inner sides respectively and oppositely provided with a plurality of lugs 33.

The cover plate 4 is to be pivotally assembled with the upper sides of the two opposite side plates 3 by pivots 7 and has three peripheral sides respectively disposed with a pivot suspension 40 and an upper side installed with a heater 41 having a topside provided thereon with a lifting handle 42, further having two opposite upper sides respectively provided with two projections 43.

The support plate 5 with a through hole 51 is pivotally assembled at another side of the cover plate 4 by a pivot 7, formed with a pivot suspension 50 to be pivotally combined with the pivot suspension 40 at another side of the cover plate 4.

The two hanging plates 6 are to be respectively mounted at the front side and the rear side of the base tray 2 and the two opposite side plates 3 and the cover plate 4. Each hanging plate 6 has its upper edge bent to form a hanging lug 60 and bored with two hanging holes 61 and its wall surface fixed thereon with a lifting lug 62.

In assembling, referring to FIGS. 2 and 3, firstly, the two side plates 3, the base tray 2 and the cover plate 4 are mutually assembled together by plural pivots 7 respectively inserted in the pivot suspensions 20, 31, and 41, and then the support plate 5 is pivotally fixed at the lower side of the cover plate 4 and turned downward to let its lower edge resist the base tray 2 for propping up and positioning the two side plates 3 and the cover plate 4. Subsequently, the two hanging plates 6 are respectively hung on another two opposites sides of the cover plate 4 to finish assembly of the smokeless portable roaster.

To spread out the roaster of this invention for use, only hold the lifting handle 42 on the heater 41 of the cover plate 4 and pull up the cover plate 4. At this time, the folding plates 30 of the two side plates 3 will be stretched in an erect state, and the support plate 5 will turn and move downward due to its own weight to have its lower edge resisting the base tray 2 for propping up and positioning the two side plates 3 and the cover plate 4, thus quickly and conveniently spreading out the roaster for use.

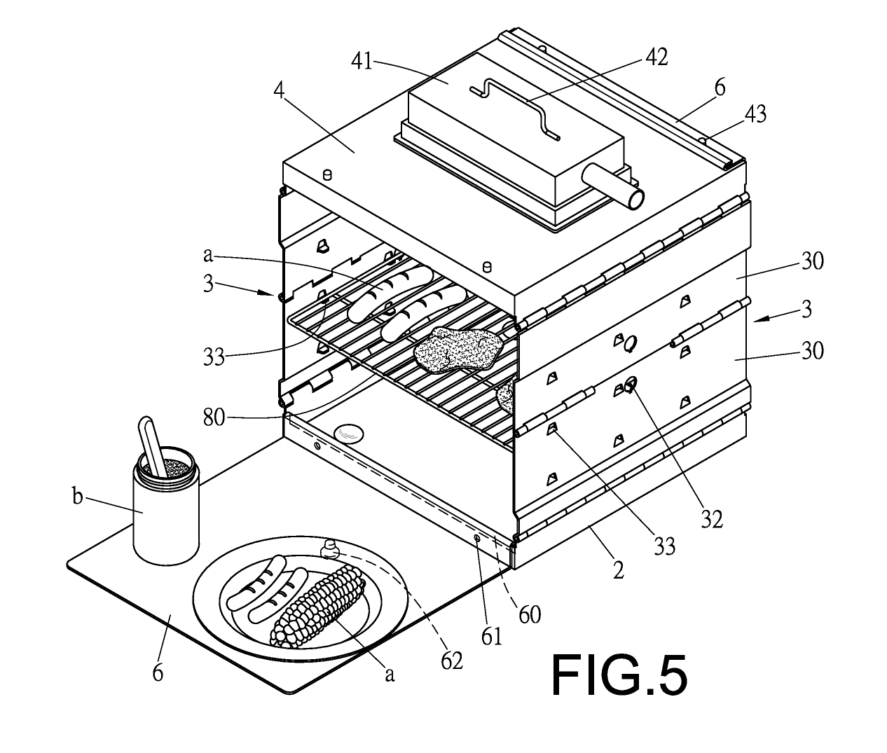

To use the roaster for carrying out one-way roasting, referring to FIG. 5, simply have one of the two hanging plates 6 hung on one side of the cover plate 4 and another hanging plate 6 hung on another edge of the base stray 2 via the hanging lug 60, letting the lifting lug 62 of another hanging plate 6 rest on the ground or on a table top to serve as a support member. Thus, this hanging plate 6 can be supported to form a horizontal article-placing surface for setting food (a) to be roasted or roasted food (a) and seasoning (b) thereon. Next, have a roasting net 80 setting on the lugs 33 on the inner sides of the two opposite side plates 3 to position the roasting net 80 between the two side plates 3 and then start the heater 41 on the cover plate 4 to carry out roasting to the food (a) on the roasting net 80. When carrying out one-way roasting, the roaster of this invention is able to keep off the wind at three sides so that heat produced by the heater 41 can be concentrated and heat source can spread from the upper side to the lower side of the roaster for elevating efficiency of food roasting. By so designing, the roaster of this invention can not only attain efficacy of energy conservation and carbon reduction and maintaining a smokeless, non-toxic and pollution-free environment, but also prevent dust, mosquitoes, flies or other suspended impurities from sticking to the food (a), able to keep the food (a) sanitary and avoid danger caused by fierce fire produced by burning charcoal.

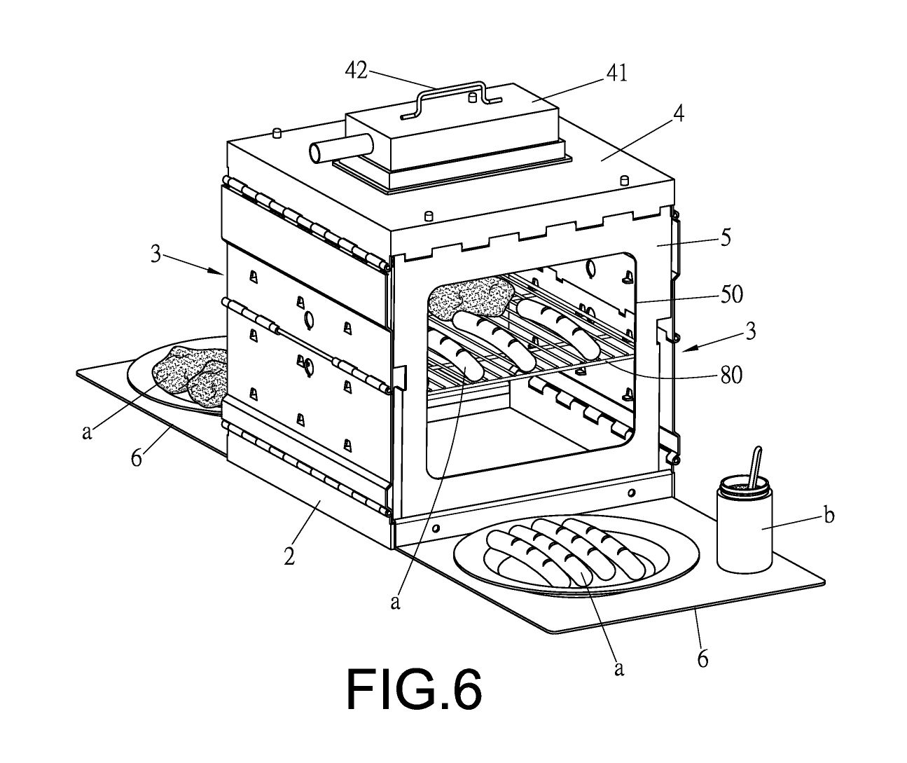

Further, referring to FIG. 6, the two hanging plates 6 can be removed from the cover plate 4 and respectively hung horizontally at the front edge and the rear edge of the base tray 2 so that two persons can carry out food roasting at the same time at the front side and the rear side of the roaster. Thus, it is convenient for the two persons who are roasting food to watch roasting conditions of the front and the rear portions of the food (a) being roasted in the roaster and timely turn over the food (a) and apply seasoning to the food (a).

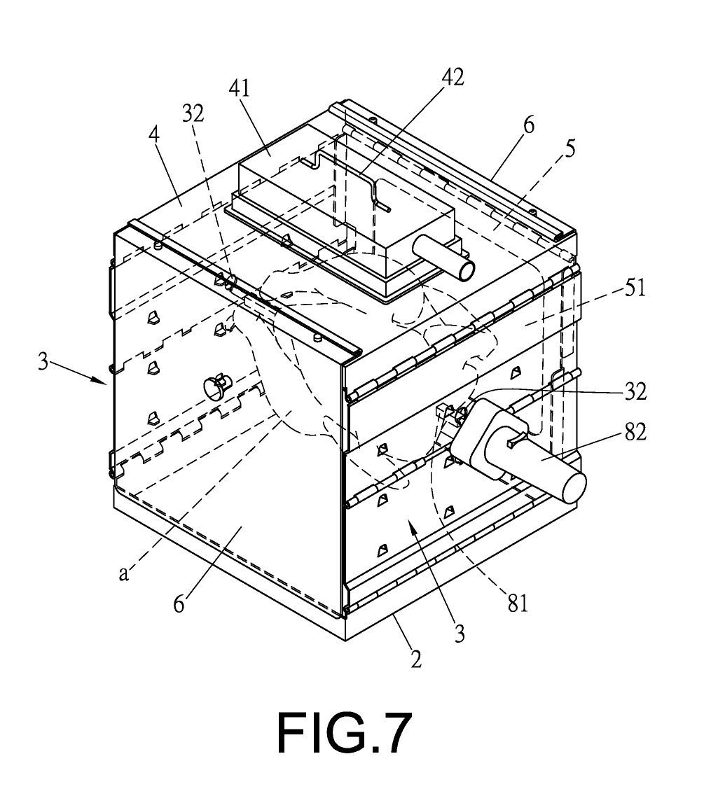

Furthermore, referring to FIG. 7, the roaster of this invention can carry out roasting for large-sized food (a), such as a whole chicken. For this purpose, an insert rod 81 is inserted through the food (a) and has its two ends respectively inserted in the insert holes 32 of the two opposite side plates 3, and one end of the insert rod 81, which is inserted out of one side plate 3, is assembled thereon with an actuator 82. Then, the two hanging plates 6 are respectively hung at the front side and the rear side of the base tray 2 and the two side plates 3 and the cover plate 4 to make up a box-type roaster to be used as an oven. Thus, when the actuator 82 drives the insert rod 81 to turn around, the food (a) will be rotated together with the insert rod 81 to enable the food (a) to be heated evenly by the heater 41 on the cover plate 4. Specifically, the portable roaster of this invention is able to prevent heat energy from dispersing out and hence achieving a best roasting effect, extremely convenient in use and applicable to being employed in a room and at a suburban district.

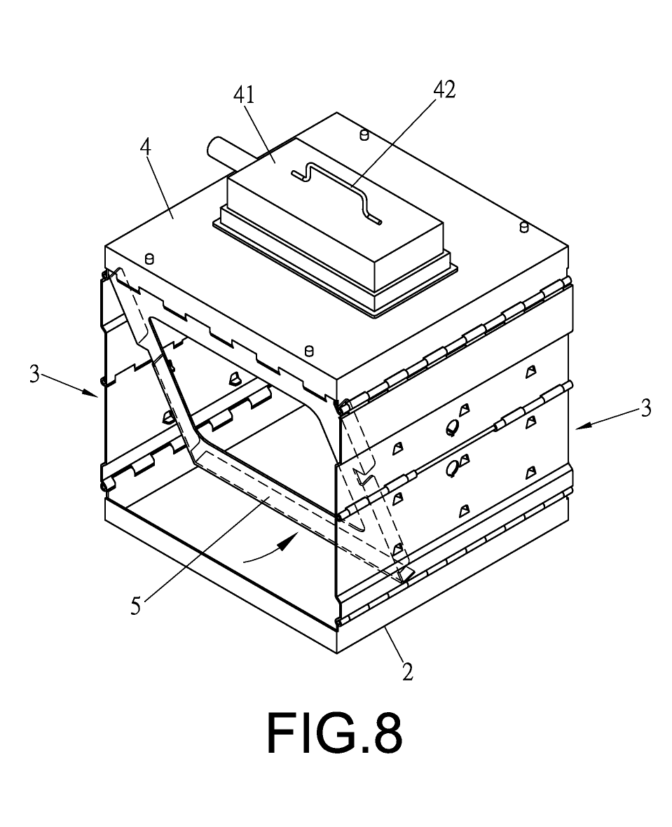

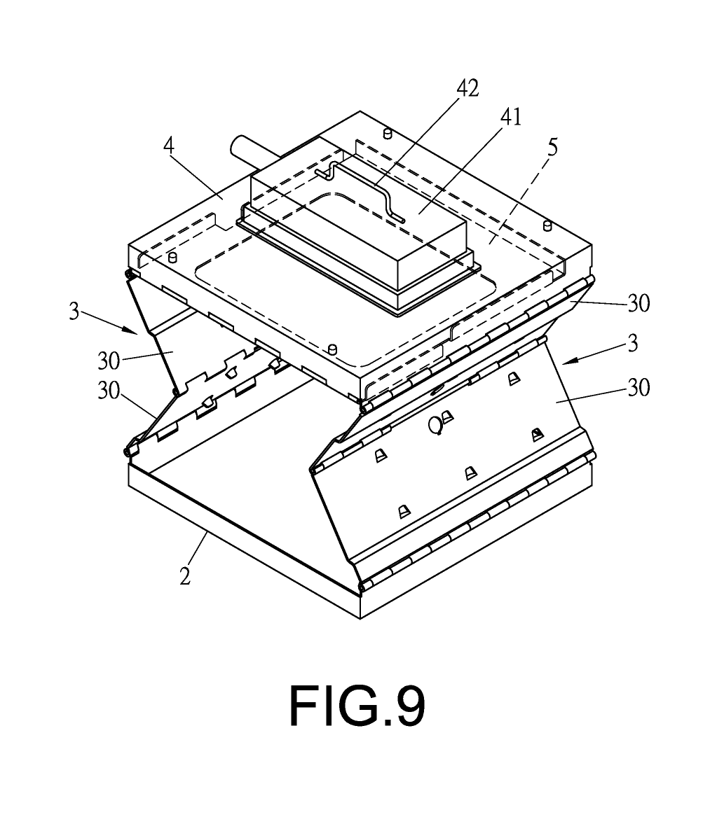

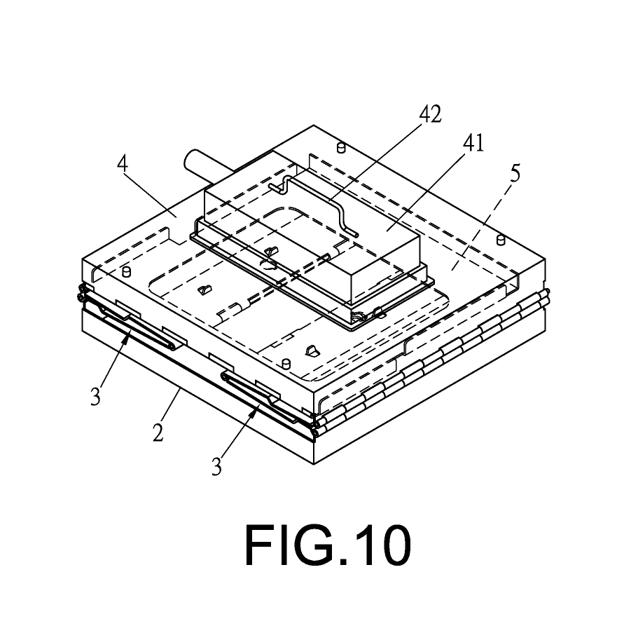

When the roaster of this invention is not in use, referring to FIGS. 8-10, only remove the two hanging plates 6 from the cover plate 4 and then push the lower edge of the support plate 5 inward and turn the support plate 5 upward with the pivot suspensions 50 and 40 of both the support plate 5 and the cover plate 4 acting as a fulcrum shaft, letting the support plate 5 horizontally received inside the cover plate 4. Next, have the intermediate pivotal portions of the two folding plates 30 of the two side plates 3 pushed inward to make the two folding plates 30 superposed on each other and received in the base tray 2 and let the cover plate superposed on the base tray 2. Thus, the smokeless portable roaster of this invention can quickly and conveniently be collapsed and spread out for use and after collapsed, the whole volume of the roaster is diminished, needless to take much space and convenient to be carried around.

While the preferred embodiment of the invention has been described above, it will be recognized and understood that various modifications may be made therein and the appended claims are intended to cover all such modifications that may fall within the spirit and scope of the invention.

What is claimed is:

1. A smokeless portable roaster comprising:
a base tray, said base tray having two opposite sides respectively provided with a pivot suspension;
two side plates oppositely and pivotally assembled at two sides of said base tray, each said side plate composed of two folding plates pivotally combined together, said two folding plates having their upper and lower edges respectively disposed with a pivot suspension, said pivot suspensions assembled with pivots of said two folding plates acting as a folding shaft;
a cover plate pivotally mounted on said two opposite side plates, said cover plate having peripheral sides respectively formed with a pivot suspension, said cover plate having an upper side installed thereon with a heater, said heater having a topside provided with a lifting handle;
a support plate pivotally assembled at another side of said cover plate, said support plate having an upper edge provided with a pivot suspension to be pivotally combined with said pivotal portion at another side of said cover plate, said support plate bored with a through hole; and
two hanging plates respectively positioned at a front side and a rear side of said base tray and said two opposite side plates and said cover plate.

2. The smokeless portable roaster as claimed in claim 1, wherein said two folding plates of each said side plate have a central pivot suspension assembled with a pivot, a butt joint pivot suspension formed at a lower edge pivotally assembled with said pivot suspension at two sides of said base tray, said cover plate pivotally assembled with said pivotal portions at upper sides of said two opposite side plates by pivots, said support plate having said pivotal portion at the upper edge pivotally connected with said pivotal portion at another side of said cover plate by a pivot.

3. The smokeless portable roaster as claimed in claim 1, wherein said base tray, said two side plates, said cover plate and said two hanging plates can be assembled together to make up a box-type roaster.

4. The smokeless portable roaster as claimed in claim 1, wherein said two side plates have their surfaces respectively and oppositely bored with at least one insert hole and their opposite inner sides respectively fixed with a plurality of lugs.

5. The smokeless portable roaster as claimed in claim 1, wherein topside of said cover plate oppositely and respectively provided with two projections and the upper edge of each said hanging plate is bored with two hanging holes.

6. The smokeless portable roaster as claimed in claim 1, wherein each said hanging plate has an upper edge bent to form a hanging lug and a wall surface provided with a lifting lug.
